(19) United States
(12) Patent Application Publication
(10) Pub. No.: US 2022/0374678 A1
(43) Pub. Date: Nov. 24, 2022

(54) METHOD FOR DETERMINING PRE-TRAINING MODEL, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Teng Xi, Beijing (CN); Can Cao, Beijing (CN); Gang Zhang, Beijing (CN)

(73) Assignee: BEIJING BAIDU NETCOM SCIENCE TECHNOLOGY CO., LTD., Beijing (CN)

(21) Appl. No.: 17/817,449

(22) Filed: Aug. 4, 2022

(30) Foreign Application Priority Data
Aug. 6, 2021 (CN) 202110903956.2

(51) Int. Cl. G06N 3/04

(52) U.S. Cl. CPC G06N 3/04; G06V 10/776

(57) ABSTRACT

The disclosure provides a method for determining a pre-training model, an electronic device and a storage medium, relates to a technical field of computer vision and deep learning, and can be applied to scenes such as image processing and image recognition. The method includes: obtaining a plurality of candidate models; obtaining a structural code of each candidate model by performing structural coding according to model structures of the plurality of candidate models; obtaining a frequency domain code of each candidate model by mapping the structural code of each candidate model using a trained encoder; predicting a model performance parameter of each candidate model according to the frequency domain code of each candidate model; and determining a target model from the plurality of candidate models as a pre-training model according to the model performance parameter of each candidate model.

### CROSS REFERENCE TO RELATED APPLICATIONS

This application is based on and claims priority to Chinese patent applications Serial No. 202110903956.2 filed on Aug. 6, 2021, the entire contents of which are incorporated herein by reference.

### TECHNICAL FIELD

The disclosure relates to a technical field of artificial intelligence (AI), in particular to a technical field of computer vision and deep learning, and can be applied to scenes such as image processing and image recognition, in particular relates to a method for determining a pre-training model, an electronic device and a storage medium.

### BACKGROUND

A pre-training model is widely used to improve an effect of upper AI tasks. In an upstream task, the pre-training model is pre-trained with a large number of training data, which can achieve a better prediction result when the model is trained with a small amount of training data in a downstream task. Therefore, how to reduce a training cost of the pre-training model and improve a training efficiency is very important.

### SUMMARY

Embodiments of the disclosure provide a method for determining a pre-training model, an electronic device and a storage medium.

According to a first aspect of the disclosure, a method for determining a pre-training model is provided. The method includes: obtaining a plurality of candidate models; obtaining a structural code of each candidate model by performing structural coding according to model structures of the plurality of candidate models; obtaining a frequency domain code of each candidate model by mapping the structural code of each candidate model using a trained encoder; predicting a model performance parameter of each candidate model according to the frequency domain code of each candidate model; and determining a target model from the plurality of candidate models as a pre-training model according to the model performance parameter of each candidate model.

According to a second aspect of the disclosure, an electronic device is provided. The electronic device includes: at least one processor and a memory communicatively coupled to the at least one processor. The memory stores instructions executable by the at least one processor, and when the instructions are executed by the at least one processor, the at least one processor is caused to implement the method for determining a pre-training model described above.

According to a third aspect of the disclosure, a non-transitory computer-readable storage medium having computer instructions stored thereon is provided. The computer instructions are configured to cause a computer to implement the method for determining a pre-training model described above.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a flowchart of a method for determining a pre-training model according to a first embodiment of the disclosure.

FIG. 2 is a flowchart of a method for determining a pre-training model according to a second embodiment of the disclosure.

FIG. 3 is a flowchart of a method for determining a pre-training model according to a third embodiment of the disclosure.

FIG. 4 is a block diagram of an apparatus for determining a pre-training model according to a fourth embodiment of the disclosure.

FIG. 5 is a block diagram of an apparatus for determining a pre-training model according to a fifth embodiment of the disclosure.

FIG. 6 is a block diagram of an electronic device for implementing a method for determining a pre-training model according to an embodiment of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

Currently, a pre-training model is widely used to improve an effect of upper AI tasks. In an upstream task, the pre-training model is pre-trained with a large number of training data, which can achieve a better prediction result when the model is trained with a small amount of training data in a downstream task. Therefore, how to reduce a training cost of the pre-training model and improve a training efficiency is very important.

In order to reduce the training cost of the pre-training model and improve the training efficiency, the disclosure provides a method for determining a pre-training model. According to the method, a plurality of candidate models are obtained, structural coding is performed according to model structures of the plurality of candidate models to obtain a structural code of each candidate model. A trained encoder is used to map the structural code of each candidate model to obtain a corresponding frequency domain code of each candidate model. A model performance parameter of each candidate model is predicted according to the frequency domain code of each candidate model. According to the model performance parameter of each candidate model, a target model is determined as a pre-training model from the plurality of candidate models. In this way, the target model is determined from the plurality of candidate models as the pre-training model according to the frequency domain codes of the plurality of candidate models, so that the training cost of subsequent training of the pre-training model can be reduced and the training efficiency can be improved.

The method for determining a pre-training model, an apparatus for determining a pre-training model, an electronic device and a non-transitory computer-readable storage medium and a computer program product of the embodiments of the disclosure are described below with reference to the accompanying drawings.

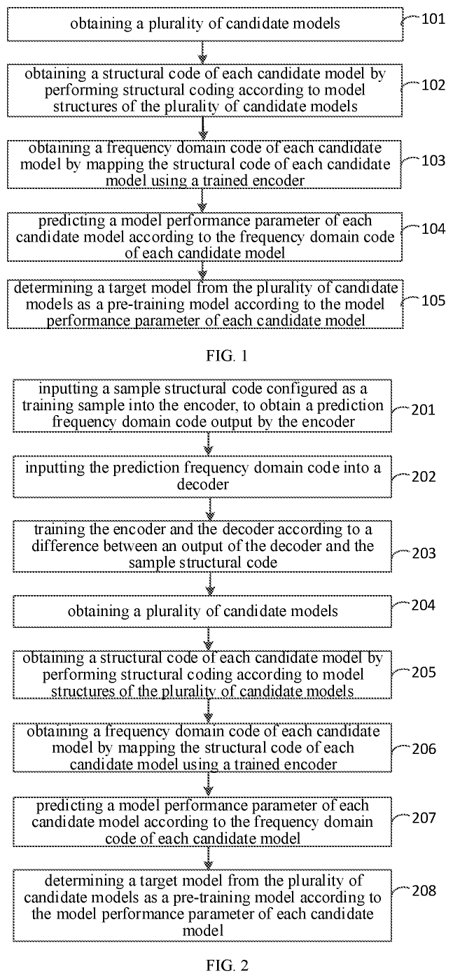

Firstly, the method for determining a pre-training model of the disclosure is described in detail in combination with FIG. 1.

FIG. 1 is a flowchart of a method for determining a pre-training model according to a first embodiment of the disclosure.

It should be noted that for the method for determining a pre-training model of the embodiments of the disclosure, an execution subject can be the apparatus for determining a pre-training model, hereinafter referred to as a determining device. The determining device can be an electronic device or can be configured in an electronic device, to determine the target model from the plurality of candidate models as the pre-training model according to the frequency domain codes of the plurality of candidate models, so as to reduce the training cost of subsequent training of the pre-training model and improve the training efficiency. The embodiments of the disclosure are explained by taking the determining device configured in the electronic device as an example.

The electronic device can be any static or mobile computing device capable of data processing, for example, mobile computing devices such as notebook computers, smart phones and wearable devices, or static computing devices such as desktop computers, or servers, or other types of computing devices, which is not limited in the disclosure.

As illustrated in FIG. 1, the method for determining a pre-training model includes the following steps.

At block 101, a plurality of candidate models are obtained.

Each candidate model is composed of a plurality of trained sub-models. The plurality of trained sub-models can be neural network models or other types of models, which is not limited in the disclosure.

At block 102, a structural code of each candidate model is obtained by performing structural coding according to model structures of the plurality of candidate models.

In an embodiment, for each candidate model in the plurality of candidate models, the structural coding can be carried out according to the model structure of the candidate model, so that the structural code of the candidate model can be obtained.

In the structural code of the candidate model, each term corresponds to a layer of the candidate model, in which one layer can be understood as one of the plurality of sub-models of the candidate model, and a value of each term is a model type of the one-layer sub-model corresponding to the term.

For example, suppose that each sub-model of the candidate model is selected from a model set, which includes 10000 types of sub-models. Candidate model A includes 6 layers, and each layer corresponds to one term of the structural code of candidate model A. Correspondingly, the structural code of candidate model A includes 6 terms, and each term has 10000 possible values. Suppose that the model type of the first layer sub-model of candidate model A is numbered 5 in the model set, the model type of the second layer sub-model is numbered 2 in the model set, the model type of the third layer sub-model is numbered 9 in the model set, the model type of the fourth layer sub-model is numbered 8 in the model set, and the model type of the fifth layer sub-model is numbered 7 in the model set, and the model type of the sixth layer sub-model is numbered 4 in the model set. Then, structural coding is performed according to the model structure of candidate model A, to obtain the structural code of candidate model A which is [5,2,9,8,7,4].

At block 103, a corresponding frequency domain code is obtained by mapping the structural code of each candidate model using a trained encoder.

In an embodiment, the encoder can be trained in advance, and an input of the encoder is the structural code and an output is the corresponding frequency domain code, so that the structural code of each candidate model can be input into the trained encoder respectively, to obtain the frequency domain code corresponding to the structural code of each candidate model, thus achieving mapping of the structural code of each candidate model to the corresponding frequency domain code.

At block 104, a model performance parameter of each candidate model is predicted according to the frequency domain code of each candidate model.

The model performance parameter of the candidate model can represent a performance of the candidate model. The model performance parameter can include a parameter representing an accuracy of the candidate model and a parameter representing a processing speed of the candidate model.

In an embodiment, a correlation function describing a correlation between the frequency domain code and the model performance parameter of the corresponding candidate model can be obtained by statistical processing in advance. A parameter of the correlation function can be obtained by a maximum likelihood estimation in a frequency domain. Thus, after obtaining the frequency domain code of each candidate model, the model performance parameter of each candidate model can be predicted according to the correlation function describing the correlation between the frequency domain code and the model performance parameter of the corresponding candidate model. For the specific statistical method to obtain the correlation function, refers to the relevant technology, which will not be repeated here.

At block 105, a target model is determined from the plurality of candidate models as a pre-training model according to the model performance parameter of each candidate model.

The number of pre-training models determined from the plurality of candidate models can be preset as needed, for example, the number can be preset as one or more, which is not limited in the disclosure.

In an embodiment, after the model performance parameter of each candidate model is predicted, the candidate models can be sorted by performance in a descending order according to the model performance parameter, so that the preset number of target models ranking first can be determined from the plurality of candidate models as the pre-training models, and then the pre-training models can be trained to adapt to various tasks such as face recognition, image processing, and commodity classification.

After obtaining the plurality of candidate models, the target model is determined from the plurality of candidate models as the pre-training model according to the frequency domain codes of the plurality of candidate models. Afterwards, it is unnecessary to train each candidate model, but only to train the determined pre-training model, which can reduce the training cost of the pre-training model and improve the training efficiency. In addition, the pre-training model is selected according to the model performance parameter of each candidate model, so that the candidate model with the fastest processing speed under the same accuracy can be selected from the candidate models as the pre-training model. After training the pre-training model, when performing tasks such as image processing and image recognition, the speed of model processing or image recognition on specific hardware is improved, or the same speed and accuracy of the model on high-cost hardware can be achieved on low-cost hardware. Alternatively, under the same speed, the candidate model with the highest accuracy can be selected from the candidate models as the pre-training model. After training the pre-training model, the accuracy of the model can be improved under the same hardware condition when performing tasks such as image processing and image recognition.

According to the method for determining a pre-training model of the embodiment of the disclosure, the plurality of candidate models are obtained, structural coding is performed according to the model structures of the plurality of candidate models to obtain the structural code of each candidate model. Then, the trained encoder is used to map the structural code of each candidate model to obtain the corresponding frequency domain code. The model performance parameter of each candidate model is predicted according to the frequency domain code of each candidate model. According to the model performance parameter of each candidate model, the target model is determined from the plurality of candidate models as the pre-training model. Therefore, the target model is determined from the plurality of candidate models as the pre-training model according to the frequency domain codes of the plurality of candidate models, so that the training cost of subsequent training of the pre-training model can be reduced and the training efficiency can be improved.

Through the above analysis, it can be seen that in the embodiment of the disclosure, the encoder can be trained in advance, so that the trained encoder can be used to map the structural code of each candidate model to obtain the corresponding frequency domain code. The process for training the encoder in the method for determining a pre-training model of the disclosure is further described in combination with FIG. 2.

FIG. 2 is a flowchart of a method for determining a pre-training model according to a second embodiment of the disclosure. As illustrated in FIG. 2, the method for determining a pre-training model includes the following steps.

At block 201, a sample structural code configured as a training sample is input into the encoder, to obtain a prediction frequency domain code output by the encoder.

The sample structural code can be obtained by performing structural coding on a sample model according to a model structure of the sample model. Regarding the process of performing structural coding on the sample model, reference can be made to the description of the above embodiment, which will not be repeated here.

At block 202, the prediction frequency domain code is input into a decoder.

At block 203, the encoder and the decoder are trained according to a difference between an output of the decoder and the sample structural code.

The encoder and the decoder can be neural network models or other types of models, which is not limited in the disclosure. The input of the encoder is the structural code, and the output is the frequency domain code corresponding to the structural code. The input of the decoder is the frequency domain code, and the output is the structural code corresponding to the frequency domain code.

In an embodiment, when the encoder and the decoder are trained, for example, the encoder and the decoder can be trained by deep learning. Compared with other machine learning methods, deep learning performs better on large data sets.

When training the encoder and the decoder through deep learning, one or more sample structural codes in the training samples can be input into the encoder to obtain the prediction frequency domain code corresponding to the sample structural code output by the encoder. Then the prediction frequency domain code output by the encoder can be input into the decoder to obtain the prediction structural code corresponding to the prediction frequency domain code output by the decoder. Combined with the sample structural code, the difference between the output of the decoder and the sample structural code is obtained, and then the parameters of the encoder and the decoder are adjusted according to the difference between the output of the decoder and the sample structural code to obtain the adjusted encoder and the adjusted decoder.

Then another one or more sample structural codes in the training data are input into the adjusted encoder, to obtain the prediction frequency domain code corresponding to the sample structural code output by the adjusted encoder. The prediction frequency domain code output by the adjusted encoder is input into the adjusted decoder, to obtain the prediction structural code corresponding to the prediction frequency domain code output by the adjusted decoder. Combined with the sample structural code, the difference between the output of the adjusted decoder and the sample structural code is obtained, and then the parameters of the adjusted encoder and the adjusted decoder are adjusted according to the difference between the output of the adjusted decoder and the sample structural code, to obtain the further adjusted encoder and the further adjusted decoder.

Thus, the encoder and the decoder are iteratively trained by continuously adjusting the parameters of the encoder and the decoder until the accuracy of the prediction structural code output by the decoder meets a preset threshold, then the training is completed, and the trained encoder and the trained decoder are obtained.

Through the above process, the trained encoder and the trained decoder can be obtained. The trained encoder can map a structural code of a model to a frequency domain code, and the trained decoder can map a frequency domain code of a model to a structural code, which lays a foundation for subsequent using of the trained encoder to map the structural code of each candidate model to the corresponding frequency domain code.

At block 204, a plurality of candidate models are obtained.

At block 205, a structural code of each candidate model is obtained by performing structural coding according to model structures of the plurality of candidate models.

At block 206, a corresponding frequency domain code is obtained by mapping the structural code of each candidate model using a trained encoder.

In an embodiment, after the above training process is adopted to train the encoder and the decoder, when the plurality of candidate models are obtained and the structural code of each candidate model is obtained, the trained encoder can be used to map the structural code of each candidate model to obtain the corresponding frequency domain code.

At block 207, a model performance parameter of each candidate model is predicted according to the frequency domain code of each candidate model.

It should be noted that in the embodiment of the disclosure, when the structural code of each candidate model is mapped to the corresponding frequency domain code, the structural code can be mapped to a at least two-dimensional frequency domain code. The at least two-dimensional frequency domain code, for example, can include at least a time dimension and a precision dimension, so that when the model performance parameter of each candidate model is predicted according to the at least two-dimensional frequency domain code of each candidate model, the prediction accuracy can be improved.

Correspondingly, when training the encoder and the decoder, after inputting the sample structure code configured as the training sample into the encoder, at least two-dimensional coding can be carried out through the encoder to obtain the at least two-dimensional prediction frequency domain code output by the encoder. Then the at least two-dimensional prediction frequency domain code is input into the decoder, and the encoder and the decoder are trained according to the difference between the prediction structural code output by the decoder and the sample structural code. Thus, the structural code of each candidate model can be mapped to the corresponding at least two-dimensional frequency domain code by using the trained encoder, and then the model performance parameter of each candidate model can be predicted according to the at least two-dimensional frequency domain code of each candidate model, so as to improve the prediction accuracy.

At block 208, a target model is determined from the plurality of candidate models as a pre-training model according to the model performance parameter of each candidate model.

The specific implementation process and principle of steps 204-208 can refer to the description of the above embodiment, which will not be repeated here.

According to the method for determining a pre-training model of the embodiment of the disclosure, the sample structural code configured as the training sample is input into the encoder, to obtain the prediction frequency domain code output by the encoder. The prediction frequency domain code is input into the decoder. The encoder and the decoder are trained according to the difference between the output of the decoder and the sample structural code, to realize training of the encoder and the decoder. After obtaining the plurality of candidate models and performing structural coding according to the model structures of the candidate models to obtain the structural code of each candidate model, the trained encoder can be used to map the structural code of each candidate model to the corresponding frequency domain code, and then the model performance parameter of each candidate model is predicted according to the frequency domain code of each candidate model. According to the model performance parameter of each candidate model, the target model is determined from the plurality of candidate models as the pre-training model. Therefore, the target model is determined from the plurality of candidate models as the pre-training model according to the frequency domain codes of the candidate models, so that the training cost of subsequent training of the pre-training model can be reduced and the training efficiency can be improved.

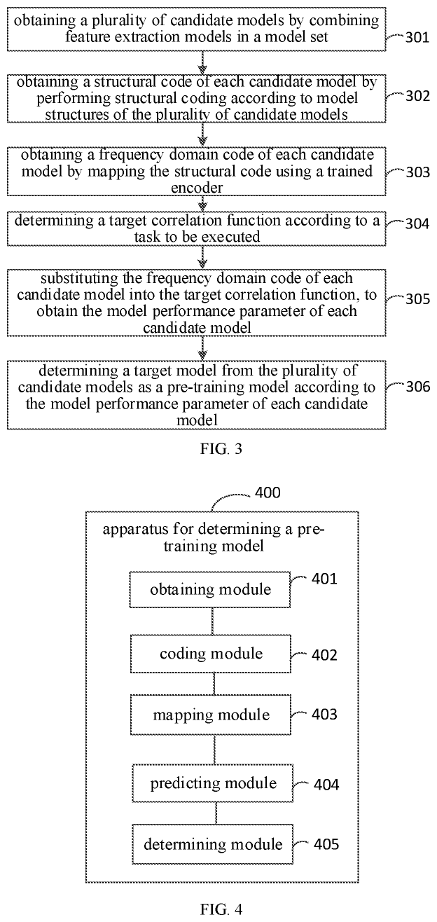

According to the above analysis, in the embodiment of the disclosure, the model performance parameter of each candidate model can be predicted according to the frequency domain code of each candidate model, and then the target model can be determined from the plurality of candidate models as the pre-training model according to the model performance parameter of each candidate model. The process of predicting the model performance parameter of each candidate model according to the frequency domain code of each candidate model in the method for determining a pre-training model of the disclosure is further described below in combination with FIG. 3.

FIG. 3 is a flowchart of a method for determining a pre-training model according to a third embodiment of the disclosure. As illustrated in FIG. 3, the method for determining a pre-training model further includes the following steps.

At block 301, a plurality of candidate models are obtained by combining feature extraction models in a model set.

The feature extraction model can be any model with a function of extracting image features in the field of computer vision and image processing.

In an embodiment, the model set includes a plurality of trained feature extraction models (i.e., sub-models in the previous embodiment), the plurality of feature extraction models can be neural network models or other types of models, which is not limited in the disclosure. In an embodiment, the plurality of feature extraction models can be selected from the model set by a random selection and combined to obtain the plurality of candidate models. Alternatively, the performance of each feature extraction model in the model set can be determined respectively, and then the plurality of feature extraction models with better performance can be selected from the model set and randomly combined to obtain the plurality of candidate models. Alternatively, the plurality of candidate models can be obtained in other ways. In the embodiment of the disclosure, the method of obtaining the plurality of candidate models is not limited.

The plurality of high-precision candidate models can be obtained by combining the feature extraction models in the model set.

At block 302, a structural code of each candidate model is obtained by performing structural coding according to model structures of the plurality of candidate models.

At block 303, a corresponding frequency domain code is obtained by mapping the structural code of each candidate model using a trained encoder.

The specific implementation process and principle of blocks 302-303 can refer to the description of the above embodiment, which will not be repeated here.

At block 304, a target correlation function is determined according to a task to be executed.

The task to be executed may be a task to be executed after the pre-training model is trained, such as face recognition task or commodity classification task.

In an embodiment, the correlation functions corresponding respectively to various tasks can be determined in advance, in which the correlation function corresponding to a task describes a correlation between the frequency domain code and the model performance parameter of the corresponding candidate model when performing the task. The parameter of the correlation function can be obtained by a maximum likelihood estimation in the frequency domain. Thus, the target correlation function corresponding to the task to be executed can be determined according to the task to be executed and the predetermined correlation functions corresponding to various tasks.

At block 305, the frequency domain code of each candidate model is substituted into the target correlation function, to obtain the model performance parameter of each candidate model.

In an embodiment, since the target correlation function describes the correlation between the frequency domain code and the model performance parameter of the corresponding candidate model when performing the task to be executed, the frequency domain code of each candidate model can be substituted into the target correlation function to obtain the model performance parameter of each candidate model.

The target correlation function is determined according to the task to be executed, and the frequency domain code of each candidate model is substituted into the target correlation function, to obtain the model performance parameter of each candidate model. In this way, according to the target correlation function corresponding to the task to be executed, the model performance parameter of each candidate model when executing the task to be executed can be accurately predicted.

At block 306, a target model is determined from the plurality of candidate models as a pre-training model according to the model performance parameter of each candidate model.

The specific implementation process and principle of block 306 can refer to the description of the above embodiment, which will not be repeated here.

According to the method for determining a pre-training model of the embodiment of the disclosure, firstly, the feature extraction models in the model set are combined to obtain the plurality of candidate models, and then the structural coding is carried out according to the model structures of the candidate models to obtain the structural code of each candidate model. The trained encoder is used to map the structural code of each candidate model to obtain the corresponding frequency domain code, and the target correlation function is determined according to the task to be executed. The frequency domain code of each candidate model is substituted into the target correlation function to obtain the model performance parameter of each candidate model, and the target model is determined from the plurality of candidate models as the pre-training model according to the model performance parameter of each candidate model. Therefore, the target model is determined from the plurality of candidate models as the pre-training model according to the frequency domain code of each candidate model, which may reduce the training cost of subsequent training of the pre-training model and improve the training efficiency.

The apparatus for determining a pre-training model according to the disclosure is described below in combination with FIG. 4.

FIG. 4 is a block diagram of an apparatus for determining a pre-training model according to a fourth embodiment of the disclosure.

As illustrated in FIG. 4, the apparatus 400 for determining a pre-training model includes: an obtaining module 401, a coding module 402, a mapping module 403, a predicting module 404 and a determining module 405.

The obtaining module 401 is configured to obtain a plurality of candidate models.

The coding module 402 is configured to obtain a structural code of each candidate model by performing structural coding according to model structures of the plurality of candidate models.

The mapping module 403 is configured to obtain a frequency domain code by mapping the structural code of each candidate model using a trained encoder.

The predicting module 404 is configured to predict a model performance parameter of each candidate model according to the frequency domain code of each candidate model.

The determining module 405 is configured to determine a target model from the plurality of candidate models as a pre-training model according to the model performance parameter of each candidate model.

It should be noted that the apparatus for determining a pre-training model of this embodiment can perform the method for determining a pre-training model described the above embodiments. The apparatus for determining a pre-training model can be an electronic device or can be configured in an electronic device, to determine the target model from the plurality of candidate models as the pre-training model according to the frequency domain codes of the plurality of candidate models, thereby reducing the training cost of subsequent training of the pre-training model and improving the training efficiency.

The electronic device can be any static or mobile computing device capable of data processing, for example, mobile computing devices such as notebook computers, smart phones and wearable devices, or static computing devices such as desktop computers, or servers, or other types of computing devices, which is not limited in the disclosure.

It should be noted that the foregoing description of the embodiments of the method for determining a pre-training model is also applicable to the apparatus for determining a pre-training model of the disclosure, which will not be repeated here.

With the apparatus for determining a pre-training model of the embodiment of the disclosure, after the plurality of candidate models are obtained, structural coding is performed according to the model structures of the plurality of candidate models to obtain the structural code of each candidate model. The trained encoder is used to map the structural code of each candidate model to obtain the corresponding frequency domain code. The model performance parameter of each candidate model is predicted according to the frequency domain code of each candidate model. According to the model performance parameter of each candidate model, the target model is determined from the plurality of candidate models as the pre-training model. Therefore, the target model is determined from the plurality of candidate models as the pre-training model according to the frequency domain codes of the plurality of candidate models, so that the training cost of subsequent training of the pre-training model can be reduced and the training efficiency can be improved.

The apparatus for determining a pre-training model according to the disclosure is described below in combination with FIG. 5.

FIG. 5 is a block diagram of an apparatus for determining a pre-training model according to a fifth embodiment of the disclosure.

As illustrated in FIG. 5, the apparatus 500 for determining a pre-training model includes: an obtaining module 501, a coding module 502, a mapping module 503, a predicting module 504 and a determining module 505. The obtaining module 501, the coding module 502, the mapping module 503, the predicting module 504 and the determining module 505 shown in FIG. 5 have the same function and structure as the obtaining module 401, the coding module 402, the mapping module 403, the predicting module 404 and the determining module 405 in FIG. 4.

In an embodiment, the apparatus 500 for determining a pre-training model may further include: a first processing module 506, a second processing module 507 and a training module 508.

The first processing module 506 is configured to input a sample structural code configured as a training sample into the encoder, to obtain a prediction frequency domain code output by the encoder.

The second processing module 507 is configured to input the prediction frequency domain code into a decoder.

The training module 508 is configured to train the encoder and the decoder according to a difference between an output of the decoder and the sample structural code.

In an embodiment, the first processing module 506 includes: a processing unit, configured to input the sample structural code configured as the training sample into the encoder for at least two-dimensional coding, to obtain a at least two-dimensional prediction frequency domain code output by the encoder.

In an embodiment, the obtaining module 501 includes: a combining unit, configured to obtain the plurality of candidate models by combining feature extraction models in a model set.

In an embodiment, the predicting module 504 includes: a determining unit, configured to determine a target correlation function according to a task to be executed; and an obtaining unit, configured to substitute the frequency domain code of each candidate model into the target correlation function, to obtain the model performance parameter of each candidate model.

It should be noted that the foregoing description of the embodiments of the method for determining a pre-training model is also applicable to the apparatus for determining a pre-training model of the disclosure, which will not be repeated here.

With the apparatus for determining a pre-training model of the embodiment of the disclosure, after the plurality of candidate models are obtained, structural coding is performed according to the model structures of the plurality of candidate models to obtain the structural code of each candidate model. Then, the trained encoder is used to map the structural code of each candidate model to obtain the corresponding frequency domain code. The model performance parameter of each candidate model is predicted according to the frequency domain code of each candidate model. According to the model performance parameter of each candidate model, the target model is determined from the plurality of candidate models as the pre-training model. Therefore, the target model is determined from the plurality of candidate models as the pre-training model according to the frequency domain codes of the plurality of candidate models, so that the training cost of subsequent training of the pre-training model can be reduced and the training efficiency can be improved.

According to the embodiments of the disclosure, the disclosure also provides an electronic device, a readable storage medium and a computer program product.

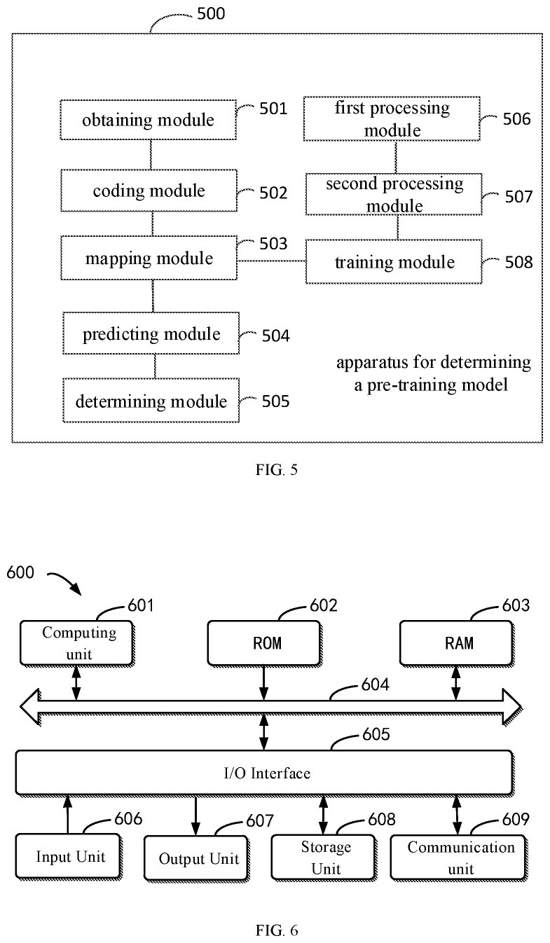

FIG. 6 is a block diagram of an example electronic device 600 used to implement the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 6, the device 600 includes a computing unit 601 performing various appropriate actions and processes based on computer programs stored in a read-only memory (ROM) 602 or computer programs loaded from the storage unit 608 to a random access memory (RAM) 603. In the RAM 603, various programs and data required for the operation of the device 600 are stored. The computing unit 601, the ROM 602, and the RAM 603 are connected to each other through a bus 604. An input/output (I/O) interface 605 is also connected to the bus 604.

Components in the device 600 are connected to the I/O interface 605, including: an inputting unit 606, such as a keyboard, a mouse; an outputting unit 607, such as various types of displays, speakers; a storage unit 608, such as a disk, an optical disk; and a communication unit 609, such as network cards, modems, and wireless communication transceivers. The communication unit 609 allows the device 600 to exchange information/data with other devices through a computer network such as the Internet and/or various telecommunication networks.

The computing unit 601 may be various general-purpose and/or dedicated processing components with processing and computing capabilities. Some examples of computing unit 601 include, but are not limited to, a central processing unit (CPU), a graphics processing unit (GPU), various dedicated AI computing chips, various computing units that run machine learning model algorithms, and a digital signal processor (DSP), and any appropriate processor, controller and microcontroller. The computing unit 601 executes the various methods and processes described above, such as the method for determining a pre-training model. For example, in some embodiments, the method for determining a pre-training model may be implemented as a computer software program, which is tangibly contained in a machine-readable medium, such as the storage unit 608. In some embodiments, part or all of the computer program may be loaded and/or installed on the device 600 via the ROM 602 and/or the communication unit 609. When the computer program is loaded on the RAM 603 and executed by the computing unit 601, one or more steps of the method for determining a pre-training model described above may be executed. Alternatively, in other embodiments, the computing unit 601 may be configured to perform the method for determining a pre-training model in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and the block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system, to solve the defects of difficult management and weak business scalability in the traditional physical host and virtual private server (VPS) service. The server can also be a server of distributed system or a server combined with block-chain.

The disclosure relates to the technical field of AI, in particular to the technical field of computer vision and deep learning, which can be applied to scenes such as image processing and image recognition.

It should be noted that AI is a subject that studies the use of computers to simulate certain human thinking processes and intelligent behaviors (such as learning, reasoning, thinking and planning), which has both hardware-level technologies and software-level technologies. AI hardware technology generally includes technologies such as sensors, special AI chips, cloud computing, distributed storage, big data processing. AI software technology mainly includes computer vision, speech recognition technology, natural language processing technology and machine learning/deep learning, big data processing technology, and knowledge graph technology.

According to the technical solution of the embodiment of the disclosure, the target model is determined from the plurality of candidate models as the pre-training model according to the frequency domain code of each candidate model, thus the training cost of subsequent training of the pre-training model can be reduced and the training efficiency can be improved.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for determining a pre-training model, comprising:
obtaining a plurality of candidate models;
obtaining a structural code of each candidate model by performing structural coding according to model structures of the plurality of candidate models;
obtaining a frequency domain code of each candidate model by mapping the structural code of each candidate model using a trained encoder;
predicting a model performance parameter of each candidate model according to the frequency domain code of each candidate model; and
determining a target model from the plurality of candidate models as a pre-training model according to the model performance parameter of each candidate model.

2. The method of claim 1, wherein the trained encoder is obtained by:
inputting a sample structural code configured as a training sample into an encoder, to obtain a prediction frequency domain code output by the encoder;
inputting the prediction frequency domain code into a decoder; and
training the encoder and the decoder according to a difference between an output of the decoder and the sample structural code so as to obtain the trained encoder.

3. The method of claim 2, wherein inputting the sample structural code configured as the training sample into the encoder, to obtain the prediction frequency domain code output by the encoder, comprises:
inputting the sample structural code configured as the training sample into the encoder for at least two-dimensional coding, to obtain a at least two-dimensional prediction frequency domain code output by the encoder.

4. The method of claim 1, wherein obtaining the plurality of candidate models comprises:
obtaining the plurality of candidate models by combining feature extraction models in a model set.

5. The method of claim 2, wherein obtaining the plurality of candidate models comprises:
obtaining the plurality of candidate models by combining feature extraction models in a model set.

6. The method of claim 3, wherein obtaining the plurality of candidate models comprises:
obtaining the plurality of candidate models by combining feature extraction models in a model set.

7. The method of claim 1, wherein predicting the model performance parameter of each candidate model according to the frequency domain code of each candidate model, comprises:
determining a target correlation function according to a task to be executed; and
substituting the frequency domain code of each candidate model into the target correlation function, to obtain the model performance parameter of each candidate model.

8. The method of claim 2, wherein predicting the model performance parameter of each candidate model according to the frequency domain code of each candidate model, comprises:
determining a target correlation function according to a task to be executed; and
substituting the frequency domain code of each candidate model into the target correlation function, to obtain the model performance parameter of each candidate model.

9. The method of claim 3, wherein predicting the model performance parameter of each candidate model according to the frequency domain code of each candidate model, comprises:
determining a target correlation function according to a task to be executed; and
substituting the frequency domain code of each candidate model into the target correlation function, to obtain the model performance parameter of each candidate model.

10. An electronic device, comprising:
at least one processor;
a memory communicatively connected to the at least one processor; wherein, the memory stores instructions that can be executed by the at least one processor, and when the instructions are executed by the at least one processor, the at least one processor is caused to implement the following:
obtaining a plurality of candidate models;
obtaining a structural code of each candidate model by performing structural coding according to model structures of the plurality of candidate models;
obtaining a frequency domain code of each candidate model by mapping the structural code of each candidate model using a trained encoder;
predicting a model performance parameter of each candidate model according to the frequency domain code of each candidate model; and
determining a target model from the plurality of candidate models as a pre-training model according to the model performance parameter of each candidate model.

11. The device of claim 10, wherein the trained encoder is obtained by:
inputting a sample structural code configured as a training sample into an encoder, to obtain a prediction frequency domain code output by the encoder;
inputting the prediction frequency domain code into a decoder; and
training the encoder and the decoder according to a difference between an output of the decoder and the sample structural code so as to obtain the trained encoder.

12. The device of claim 11, wherein inputting the sample structural code configured as the training sample into the encoder, to obtain the prediction frequency domain code output by the encoder, comprises:
inputting the sample structural code configured as the training sample into the encoder for at least two-dimensional coding, to obtain a at least two-dimensional prediction frequency domain code output by the encoder.

13. The device of claim 10, wherein obtaining the plurality of candidate models comprises:
obtaining the plurality of candidate models by combining feature extraction models in a model set.

14. The device of claim 10, wherein predicting the model performance parameter of each candidate model according to the frequency domain code of each candidate model, comprises:
determining a target correlation function according to a task to be executed; and
substituting the frequency domain code of each candidate model into the target correlation function, to obtain the model performance parameter of each candidate model.

15. A non-transitory computer-readable storage medium having computer instructions stored thereon, wherein the computer instructions are configured to cause a computer to perform the following:
obtaining a plurality of candidate models;
obtaining a structural code of each candidate model by performing structural coding according to model structures of the plurality of candidate models;
obtaining a frequency domain code of each candidate model by mapping the structural code of each candidate model using a trained encoder;
predicting a model performance parameter of each candidate model according to the frequency domain code of each candidate model; and
determining a target model from the plurality of candidate models as a pre-training model according to the model performance parameter of each candidate model.

16. The storage medium of claim 15, wherein the trained encoder is obtained by:
inputting a sample structural code configured as a training sample into an encoder, to obtain a prediction frequency domain code output by the encoder;
inputting the prediction frequency domain code into a decoder; and
training the encoder and the decoder according to a difference between an output of the decoder and the sample structural code so as to obtain the trained encoder.

17. The storage medium of claim 16, wherein inputting the sample structural code configured as the training sample into the encoder, to obtain the prediction frequency domain code output by the encoder, comprises:
inputting the sample structural code configured as the training sample into the encoder for at least two-dimensional coding, to obtain a at least two-dimensional prediction frequency domain code output by the encoder.

18. The storage medium of claim 15, wherein obtaining the plurality of candidate models comprises:
obtaining the plurality of candidate models by combining feature extraction models in a model set.

19. The storage medium of claim 15, wherein predicting the model performance parameter of each candidate model according to the frequency domain code of each candidate model, comprises:
determining a target correlation function according to a task to be executed; and
substituting the frequency domain code of each candidate model into the target correlation function, to obtain the model performance parameter of each candidate model.
